(19) United States
(12) Patent Application Publication
(10) Pub. No.: US 2002/0089163 A1
(43) Pub. Date: Jul. 11, 2002

(54) Three-point/four-point seat belt with symmettric belt configuration

(75) Inventors: Paul George Bedewi, Dearborn, MI (US); Stephen William Rouhana, Plymouth, MI (US); John L. Sullivan, Ann Arbor, MI (US)

Correspondence Address: FORD GLOBAL TECHNOLOGIES, INC, SUITE 600 - PARKLANE TOWERS EAST, ONE PARKLANE BLVD., DEARBORN, MI, 48126, US

(73) Assignee: Ford Global Technologies, Inc., Dearborn, MI

(21) Appl. No.: 09/683,473

(22) Filed: Jan. 4, 2002

Related U.S. Application Data
(60) Provisional application No. 60/260,013, filed on Jan. 5, 2001.

(51) Int. Cl. B60R 22/00

(52) U.S. Cl. 280/801.1; 280/808

(57) ABSTRACT

An occupant restraint system for a vehicle seat includes a three-point belt assembly comprising a shoulder belt and a lap belt releasably secured at an first buckle element and a supplemental shoulder belt having an upper end adjacent an upper first portion of the seat back and a lower end releasably secured to a second buckle element. The second buckle element is secured to the lap belt attachment in a position to restrain the second ends of the lap belt and supplemental shoulder belt in a configuration that is symmetric about the centerline of the seat with the configuration of the first ends of the lap belt and the shoulder belt where they are secured to the first buckle element. The load-carrying paths for the first ends of the lap belt and shoulder belt intersect one another at an intersection point that is symmetric with the intersection point where the load-carrying paths for the second ends of the lap belt and supplemental shoulder belt intersect one another about. The symmetric configuration of the belts provides for more effective and safe restraint of the occupant of the seat during rapid deceleration of the vehicle.

### BACKGROUND OF INVENTION

This application claims priority on Provisional Application Ser. No. 60/260,013, “THREE POINT/FOUR POINT SAFETY BELT WITH SYMMETRIC BELT CONFIGURATION AND COMMON ANCHORAGE POINTS,” filed Jan. 5, 2001.

The present invention relates generally to a seat belt restraint system and, more specifically, to a seat belt restraint system which may be used as either a three-point or a four-point system.

Automotive vehicle seats include a generally upright seat back mounted to a generally horizontal seat cushion for supporting a seated occupant. The seat back includes a top portion that often supports a headrest and a bottom portion that is often pivotally attached to the seat cushion for providing reclining adjustment of the seat back. The seat cushion extends between an inboard side (adjacent the center of the vehicle) and an outboard side (adjacent the door or side wall of the vehicle). A seat belt restraint system is commonly secured to the seat or the vehicle structure immediately adjacent the seat for restraining the seated occupant in the seat.

The most common type of seat belt restraint system uses a three-point seat belt configuration, generally defined by a lap belt extending between the inboard and outboard side of the seat cushion and a shoulder belt extending diagonally from the outboard top portion of the seat back to the inboard rear portion of the seat cushion. The lap belt and shoulder belt may be interconnected by a fitting that includes a latch element such as a latch plate, or they may be a single, continuous length of webbing with a buckle element that slides along the webbing to allow adjustability, the buckle element defining the boundary between the lap and shoulder belts. In either of these forms, the buckle element is releasably latched to a mating buckle element at the rear inboard side of the seat cushion. One or more locking retractors are typically provided at the ends of the belts to adjust the length of the shoulder and/or lap belt for proper fit of varying-sized seated occupants.

It has been found that under some circumstances a four-point seat belt system has advantages over the traditional three-point system described above. It has been proposed to convert the traditional three-point system to a four-point system by simply adding a second shoulder belt in the manner shown in FIG. 1. The three-point system comprises a standard, three-point shoulder/lap belt assembly 112 comprising a lap belt 114 anchored at a lower outboard anchor point 116 and a first shoulder belt 118 anchored at an upper outboard anchor point 120. The inboard ends of the lap belt 114 and first shoulder belt are releasably buckled to a lower inboard anchor point 122. A second shoulder belt 124 extends from an upper inboard anchor point 126 on the seat back, diagonally downward across the seat back, and its lower end is buckled to a shoulder belt anchor point 128 adjacent the rear outboard portion of the seat cushion. In the resulting four-point belt system, the two shoulder belts 118, 124 cross over one another at approximately the center of the seat occupant's chest. One advantage of this type of restraint system is that it may be used as a standard three-point system if the seat occupant does not choose (or forgets) to fasten the second shoulder belt 124.

To achieve optimum performance with a four-point restraint system, the belts should provide a symmetric loading on the occupant's body during a crash or other extreme deceleration. As seen in FIG. 1, however, the known four-point restraint system is not truly symmetric. The upper ends of the two shoulder belts 118, 124 can easily be made laterally symmetric by proper placement of the upper inboard anchor point 126 with respect to the upper outboard anchor point 120. But there are two separate anchor points at the outboard side of the seat: the shoulder belt anchor point 128 and the lower outboard anchor point 116 of the lap belt 114. This configuration is asymmetric with the inboard anchor point, where the lap belt 114 and the shoulder belt 118 are both connected at the same point.

### SUMMARY OF THE INVENTION

The present invention provides an occupant restraint system for a vehicle that is usable as either a three-point or a four-point belt system. The system is usable with a seat having a seat back and a seat cushion extending between first and second sides of the seat, and includes a three-point belt assembly comprising a shoulder belt having a first end adjacent an upper portion of the second side of the seat back and a second end, a lap belt having a first end adjacent the second side of the seat cushion and a second end, and a three-point latch element secured to the second end of the shoulder belt and the second end of the lap belt. A first buckle element is secured adjacent the first side of the seat cushion and is releasably engageable with the three-point latch element to position the second end of the lap belt and the second end of the shoulder belt in a first fastened configuration.

The invention system further includes a supplemental shoulder belt having a first end secured adjacent an upper portion of the first side of the seat back and a second latch element secured to a second end thereof. A second buckle element is disposed adjacent the second side of the seat cushion and is releasably engageable with the shoulder belt latch element. The second buckle element is secured to the lap belt adjacent the first end thereof in a position such that engagement of the shoulder belt latch element with the second buckle element connects the second end of the supplemental shoulder belt to the lap belt are in a second fastened configuration symmetric with the first fastened configuration.

The symmetric configuration of the belts attached to the inboard and outboard anchors provides for more effective and safe restraint of the occupant of the seat during rapid deceleration of the vehicle.

According to another feature of the invention, engagement of the three-point latch element with the first buckle element forms a first shoulder belt load path and a first end of a lap belt load path that intersect one another at a first intersection point, and the second buckle element is attached to the lap belt at a position such that engagement of the shoulder belt latch element with the second buckle element forms a second shoulder belt load path and a second end of the lap belt load path intersecting one another at a second intersection point, the second intersection point and the first intersection point being symmetric about a vertical reference plane passing through a longitudinal centerline of the seat. This bi-lateral symmetry has been found to provide more effective and safer restraint of an occupant utilizing a four-point belt system of this type than has been achieved in non-symmetric restraint systems.

According to another feature of the invention, the first end of the lap belt is secured at an anchor point adjacent a base of the seat and the second buckle element is secured to the lap belt at a point above the anchor point.

According to another feature of the invention, a load member has a lower end secured at an anchor point adjacent a base of second side of the seat, and the first end of the lap belt and the second buckle element are secured to an upper end of the load member.

Other features and advantages of the present invention will be readily appreciated and better understood after reading the subsequent description when considered in connection with the accompanying drawings.

### BRIEF DESCRIPTION OF DRAWINGS

FIG. 1 is a perspective view of a vehicle seat equipped with a prior art four-point seat belt restraint system.

FIG. 2 is a perspective view of a vehicle seat equipped with a seat belt restraint system according to the present invention.

FIG. 3 is a detail view of an outboard buckle and lap belt attachment according to the present invention.

FIG. 4 is a detail view of an alternative embodiment of an outboard buckle and lap belt attachment according to the present invention.

FIG. 5 is a detail view of a second embodiment of the invention wherein a lap belt is attached directly to an anchor point.

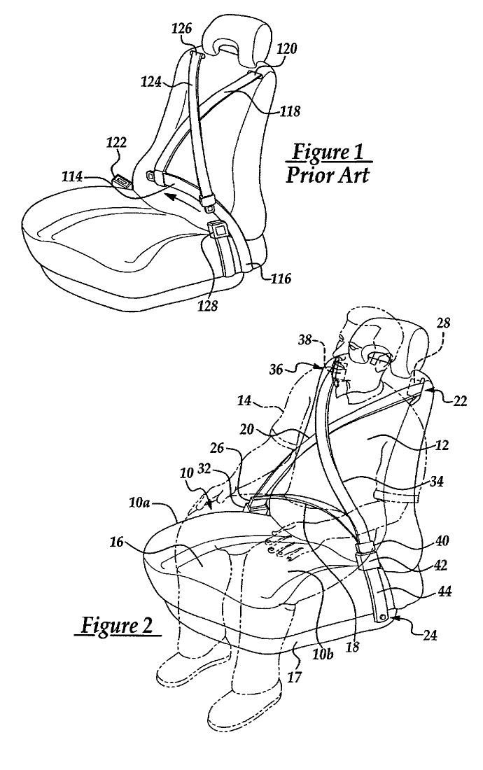

DETAILED DESCRIPTION

FIG. 2 shows a seat 10 for use in an automotive vehicle (not shown) and which includes a generally upright seat back 12 for supporting the torso of a seated occupant 14 (indicated in phantom lines), and a generally horizontal seat cushion 16 projecting forwardly from the bottom portion of the seat back 12 for supporting the pelvis and thighs of the seated occupant. A seat base 17 supports seat cushion 16. For purposes of description only, the seat 10 will be referred to herein as having an inboard side 10a and an outboard side 10b, these terms referring to the sides of the seat adjacent to a center of a vehicle and an exterior side of a vehicle respectively, as is the case if the seat is located on the left side of the vehicle. This disclosure applies equally to a seat located at any position within a vehicle.

The seat belt restraint system according to the present invention includes a three-point shoulder/lap belt assembly comprising a lap belt 18 and a shoulder belt 20. In the preferred embodiment of the invention, the lap belt 18 and shoulder belt 20 are formed by a single, continuous length of webbing having an upper end secured to an anchor point 22 adjacent the upper outboard portion of the seat back, and a lower end secured to the upper end of a load member 44 which is attached to the seat base 17 at a lower outboard anchor 24. Load member may alternatively be secured to some other vehicle structure adjacent the seat that is capable of supporting the loads placed on the belt system by a rapid vehicle deceleration, such as an anchor fitting (not shown) attached to the vehicle floor. A latch element 26, such as a latch plate, slides along the webbing to allow adjustability, and its position defines the boundary between the lap belt 18 and shoulder belt 20. As an alternative, the lap belt and shoulder belt may be formed as separate lengths of webbing connected by a fitting (not shown) that includes a latch element.

The upper outboard anchor point 22 preferably comprises a belt retractor 28 housed within or adjacent an upper outboard portion of the seat back. The belt retractor 28 is operative to retract the three-point belt when it is not fastened about the occupant 14, provide for adjustment of the length of the belt for varying-sized seated occupants, and properly position the seat belt restraint system, as is well known in the art. The belt retractor may include load limiter and/or belt pretensioner devices (not shown) of the type well known in the restraints art.

A lower inboard buckle element 32 is located adjacent the rear, inboard side of the seat cushion 16 and is lockingly engageable with the latch element 26 of the three-point belt. Buckle element 32 may be disposed at the upper end of an inboard load member (not shown) generally similar to the outboard load member 44, or may be attached to the seat and/or the vehicle in some other appropriate manner. When latch element 26 is engaged with buckle element 32 and the lap belt 18 and shoulder belt 20 are properly positioned on the occupant 14, the three-point shoulder/lap belt assembly functions in a manner well known in the art to restrain the occupant in the event of a crash or other rapid deceleration of the vehicle. The terms latch element and buckle element are used herein for convenience and refer to any type of lockingly engageable components, and do not imply that one element is necessarily male and the other female.

The invention restraint system further includes a second, supplemental shoulder belt 34 having an upper end secured to an anchor point 36 adjacent the upper inboard portion of the seat back 12. The upper inboard anchor point 36 preferably comprises a belt retractor 38 generally similar to that at the upper outboard anchor point 22. A latch element 40 is secured to the lower end of the supplemental shoulder belt 34 and is lockingly engageable with an outboard buckle element 42 disposed on load member 44. See FIG. 3.

As best seen in FIG. 3, outboard buckle element 42 is rigidly fixed to the upper end of load member 44 and may comprise any appropriate type of manually and/or automatically actuatable mechanism of the type known in the restraints art. Load member 44 may comprise a steel cable 43 surrounded by a boot 45 made of plastic or elastomer, or the load member may be rigid. A belt attachment 46 is fixed to the load member 44 at a point immediately below the outboard buckle element 42. Belt attachment 46 is secured to the outboard end of lap belt 18 so that the lap belt 18 extends toward the inboard side of the seat. In the embodiment depicted in FIG. 3, belt attachment 46 comprises a D-ring having an opening through which lap belt 18 is looped, the lap belt 18 being folded back on itself and stitched or otherwise secured to itself in the manner well known in the art.

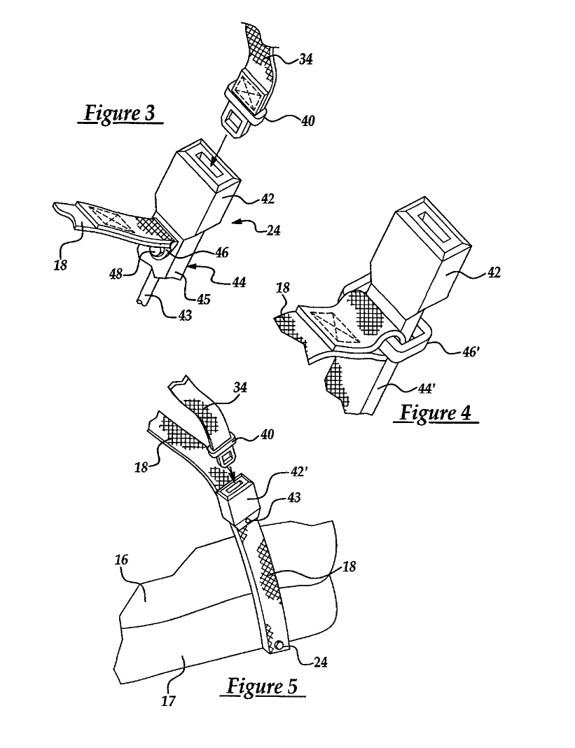

Belt attachment 46 is shown to be a D-ring fixed to the load member 44 by a bolt 48, but any type of appropriate connection may be used. For example, FIG. 4 depicts an embodiment wherein a belt attachment 46′ comprises a ring-like element welded or otherwise secured to the load member 44′.

Buckle element 42 is positioned relative to lap belt 18 and to belt attachment 46, 46′ such that fastening latch element 40 with the buckle element places the second end of supplemental shoulder belt 34 in a parallel, overlapping relationship with the immediately adjacent portion of lap belt 18, where it connects to belt attachment 46. In this fastened condition, the configuration of the overlapping ends of the belts 18, 46 is symmetric with the configuration of the opposite, inboard end of lap belt 18 and shoulder belt 20 when latch element 26 is engaged with inboard buckle element 32. If a different type or shape of latch element and/or buckle element is used to fasten the inboard ends of lap belt 18 and shoulder belt 20 around the seat occupant, with a resulting difference in the fastened configuration of the inboard ends, then the configuration of the outboard buckle element 42 relative to the lap belt 18 shall be altered accordingly to achieve the desired symmetry when in the fastened condition.

When supplemental shoulder belt latch element 40 is engaged with outboard buckle element 42, the load path of the tensile force in the supplemental shoulder belt 34 passes through the load member 44 and transmits the tensile force to the vehicle structure at outboard anchor 24. Similarly, the load path of the tensile force in the lap belt passes through belt attachment 36 to load member 44 and to outboard anchor 24. The two load paths intersect at an outboard load path intersection point, approximately where belt attachment 36 is secured to load member 44, and the load paths are coincident from that point down to outboard anchor 24.

Similarly, when the three-point latch element 26 is engaged with the inboard buckle element 32, a lap belt load path and a shoulder belt load path are formed that intersect at an intersection point. In the embodiment of the three-point belt system depicted here, this inboard load path intersection point is located approximately where the three-point latch element 26 engages the inboard buckle element 32.

The point at which the load paths or the outboard ends of the lap belt and the supplemental shoulder belt load path intersect is symmetric with the point on the inboard buckle element 32 where the corresponding load paths for the inboard ends of the lap belt 18 and the shoulder belt 20 intersect.

The term symmetric, as used herein, refers to bi-lateral symmetry about a vertical plane passing through a longitudinal centerline of the seat 10. This bi-lateral symmetry has been found to provide more effective and safer restraint of an occupant utilizing a four-point belt system of this type than has been achieved in non-symmetric restraint systems. Because the outboard load path intersection point is substantially higher than outboard anchor point 24 and is closer to the seat occupant's pelvis, lap belt 18 and supplemental shoulder belt 34 do not tend to separate or spread apart near the attachment point when the belts are loaded during a rapid deceleration. This results in lap belt 18 assuming some of the loading that would otherwise be carried by supplemental shoulder belt 34, which is beneficial because it tends to prevent the shoulder belt from riding up, and because it reduces loading on the occupant's thoracic region.

In a second embodiment of the invention shown in FIG. 5, load member 44 of the previous embodiment is dispensed with and the webbing of lap belt 18 is attached directly to outboard anchor 24 on seat base 17 or other adjacent structure, such as an anchor fitting (not shown) attached to the vehicle floor. Outboard buckle element 42′ is secured to lap belt 18 at a position above the anchor 24. Buckle element 42′ is attached to lap belt 18 by a rivet 43, for example, or by any other appropriate method such as sewing or clamping. Alternatively, buckle element 42′ may be slidable along lap belt 18 for adjustment. As in the first embodiment, buckle element 42′ is located on lap belt 18 such that when latch elements 26, 40 are engaged with respective buckle elements 32, 42′ the belt configurations at the outboard and inboard sides of seat 10 are symmetric.

A preferred embodiment of the invention restraint system includes a buckle interlock system (not shown) linking the inboard anchor buckle element 32 and the outboard anchor buckle element 42. Such a system provides an electro-mechanical connection making it impossible for the supplemental shoulder belt latch element 40 to be lockingly engaged with the outboard anchor buckle element 42 unless the three-point latch element 26 is lockingly engaged with the inboard anchor buckle element 32. This prevents an occupant from operating the vehicle while wearing only the supplemental shoulder belt 34 without having the three-point assembly fastened.

This may also be achieved by providing an interlock between the inboard anchor buckle element 32 and the belt retractor 38 for the supplemental shoulder belt 34 in order to prevent extraction of the supplemental shoulder belt unless three-point latch element 26 is lockingly engaged with the inboard anchor buckle element 32.

The belt buckle interlock system also allows an occupant to unfasten the threepoint belt and the supplemental shoulder belt simultaneously by actuating the release mechanism of either the outboard buckle element 42 or the inboard buckle element 32. A buckle interlock system of this type is disclosed in U.S. Pat. No. 5,123,673, the disclosure of which is incorporated herein by reference.

While the best modes for carrying out the invention have been described in detail, those familiar with the art to which this invention relates will recognize various alternative designs and embodiments for practicing the invention as defined by the appended claims.

1. A seat belt restraint system for a vehicle seat having a seat back and a seat cushion extending between a first side and a second side of the seat, the seat belt restraint system comprising:
a three-point belt assembly comprising a shoulder belt having a first end secured adjacent an upper portion of the second side of the seat back and a second end, a lap belt having a first end secured adjacent the second side of the seat cushion and a second end, and a three-point latch element attached to the second end of the shoulder belt and the second end of the lap belt;
a first buckle element secured adjacent the first side of the seat cushion and releasably engageable with the three-point latch element to position the second end of the lap belt and the second end of the shoulder belt in a first fastened configuration;
a supplemental shoulder belt having a first end secured adjacent an upper portion of the first side of the seat back and a shoulder belt latch element secured to a second end thereof; and
a second buckle element adjacent the second side of the seat cushion and releasably engageable with the shoulder belt latch element, the second buckle element secured to the lap belt adjacent the first end thereof in a position such that engagement of the shoulder belt latch element with the second buckle element connects the second end of the supplemental shoulder belt to the lap belt are in a second fastened configuration symmetric with the first fastened configuration.

2. The seat belt restraint system according to claim 1 wherein the first end of the lap belt is secured at an anchor point adjacent a base of the seat and the second buckle element is secured to the lap belt at a point above the anchor point.

3. The seat belt restraint system according to claim 1 wherein a load member has a lower end secured at an anchor point adjacent a base of second side of the seat, the first end of the lap belt and the second buckle element being secured to an upper end of the load member.

4. The seat belt restraint system according to claim 3 wherein the first end of the lap belt is secured to the load member by a D-ring.

5. The seat belt restraint system according to claim 1 wherein when the second end of the supplemental shoulder belt and the lap belt are in the second fastened configuration the second end of the supplemental shoulder belt is in a parallel, overlapping relationship with an immediately adjacent portion of the lap belt.

6. The seat belt restraint system according to claim 1 wherein the lap belt and the shoulder belt are formed from a single length of webbing and the first latch element slidingly engages the length of webbing for adjustable travel therealong.

7. The seat belt restraint system according to claim 1 further comprising a belt retractor disposed adjacent the seat and engaging at least one of the lap belt, the shoulder belt, and the supplemental shoulder belt.

8. The seat belt restraint system according to claim 1 further comprising a buckle interlock system operative to prevent engagement of the second latch element with the second buckle element unless the first latch element is engaged with the first buckle element.

9. The seat belt restraint system according to claim 8 wherein the buckle interlock system prevents extraction of the supplemental shoulder belt from a belt retractor unless the first latch element is engaged with the first buckle element.

10. A seat belt restraint system for a vehicle seat having a seat back and a seat cushion extending between an first and second side of the seat, the seat belt restraint system comprising:
a three-point belt assembly comprising a shoulder belt having a first end adjacent an upper second portion of the seat back and a second end, a lap belt having a first end adjacent the second side of the seat cushion and a second end, and a first latch element secured to the second end of the shoulder belt and the second end of the lap belt;
a first buckle element secured adjacent the first side of the seat cushion and releasably engageable with the three-point latch element to form a first shoulder belt load path intersecting a first end of a lap belt load at a first intersection point;
a supplemental shoulder belt having a first end adjacent an upper first portion of the seat back and a second latch element secured to a second end; and
a second buckle element adjacent the second side of the seat cushion and releasably engageable with the shoulder belt latch element to form a second shoulder belt load path, the second buckle element attached to the lap belt at a position adjacent the first end thereof such that the second shoulder belt load path intersects a second end of the lap belt load path at a second intersection point, the second intersection point and the first intersection point being symmetric about a vertical reference plane passing through a longitudinal centerline of the seat.

11. The seat belt restraint system according to claim 10 wherein the first end of the lap belt is secured at an anchor point adjacent a base of the seat and the second buckle element is secured to the lap belt at a point above the anchor point.

12. The seat belt restraint system according to claim 10 wherein a load member has a lower end secured at an anchor point adjacent a base of second side of the seat, the first end of the lap belt and the second buckle element being secured to an upper end of the load member.

13. The seat belt restraint system according to claim 12 wherein the first end of the lap belt is secured to the load member by a D-ring.

14. The seat belt restraint system according to claim 10 wherein when the second buckle element is engaged with the shoulder belt latch element the second end of the supplemental shoulder belt is in a parallel, overlapping relationship with an immediately adjacent portion of the lap belt.

15. The seat belt restraint system according to claim 10 wherein the lap belt and the shoulder belt are formed from a single length of webbing and the first latch element slidingly engages the length of webbing for adjustable travel therealong.

16. The seat belt restraint system according to claim 10 further comprising a belt retractor disposed adjacent the seat and engaging at least one of the lap belt, the shoulder belt, and the supplemental shoulder belt.

17. The seat belt restraint system according to claim 10 further comprising a buckle interlock system operative to prevent engagement of the second latch element with the second buckle element unless the first latch element is engaged with the first buckle element.

18. The seat belt restraint system according to claim 17 wherein the buckle interlock system prevents extraction of the supplemental shoulder belt from a belt retractor unless the first latch element is engaged with the first buckle element.
